(19) United States
(12) Patent Application Publication
(10) Pub. No.: US 2022/0066029 A1
(43) Pub. Date: Mar. 3, 2022

(54) Method and Apparatus for Measuring Discrete Locations Around Perimeter of Swimming Pools

(71) Applicant: Tara Manufacturing, Inc., Owens Cross Roads, AL (US)

(72) Inventors: Jerry W. Johnson, Owens Cross Roads, AL (US); Matt Nuss, Owens Cross Roads, AL (US); Michael Kranz, Owens Cross Roads, AL (US)

(73) Assignee: Tara Manufacturing, Inc., Owens Cross Roads, AL (US)

(21) Appl. No.: 17/010,439

(22) Filed: Sep. 2, 2020

(51) Int. Cl. G01S 17/08; H04W 4/80; G01C 15/00; G01B 11/26

(52) U.S. Cl. CPC G01S 17/08; G01B 11/26; G01C 15/002; H04W 4/80

(57) ABSTRACT

The present disclosure provides a method of measuring discrete locations around a perimeter of a pool, the method comprising positioning a laser measurement device at a reference point; aiming the laser measurement device at a discrete location of interest; determining the geometrical position and location of the discrete location of interest relative to the reference point; and storing the geometrical position and location of the discrete location of interest in a database.

### FIELD OF THE DISCLOSURE

The present disclosure pertains to the field of swimming pools. More specifically, the present disclosure pertains to an improved method and apparatus for measuring discrete fixed locations around the perimeter of a swimming pool, such as anchors used to hold covers, pool equipment installations, and pool geometry.

### BACKGROUND

Swimming pools typically have structures, equipment installations, and geometrical features that support the function, operation, and aesthetics of the pool. Example structures include items such as additional water features, steps, and benches. Equipment installations include items such as covers, ladders, and diving boards, including the anchors used to hold those in place. When designing, fabricating, and installing these structures and equipment, knowledge of their position is required. For example, the fabrication of a cover for the pool requires accurate knowledge of the relative positions of the anchors that have been placed around the pool to which the cover is attached. Measurement of these locations is time-consuming and prone to human error, leading to loss of both time and money as fabricated equipment often does not match the installation locations. Accordingly, it is desirable to have an improved method and apparatus for the measurement of discrete locations around the perimeter of a swimming pool before ordering and fabricating new equipment, such as covers and ladders. An improved method and apparatus are provided herein.

### BRIEF DESCRIPTION OF THE DRAWINGS

To further illustrate the advantages and features of the present disclosure, a more particular description of the invention will be rendered by reference to specific embodiments thereof which are illustrated in the appended drawings. It is appreciated that these drawings are not to be considered limiting in scope. The invention will be described and explained with additional specificity and detail through the use of the accompanying drawings in which:

FIG. 1 shows the prior art method of measuring discrete locations around the perimeter of a pool for the installation of equipment.

FIG. 2 shows a diagram of the laser measurement device mounted on a tripod in accordance with one embodiment of the present invention.

FIGS. 3 and 4 show diagrams of overhead views of the laser measurement device in operation in accordance with one embodiment of the present invention.

FIG. 5 shows a block diagram of the internal components of the laser measurement device in accordance with one embodiment of the present invention.

FIG. 6 shows a flowchart of the method of operation of the laser measurement device in accordance with one embodiment of the present invention.

FIG. 7 shows a diagram of anchor location markers in accordance with one embodiment of the present invention.

FIG. 8 shows the end result of a complete measurement sequence in accordance with one embodiment of the present invention.

### SUMMARY OF THE DISCLOSURE

The present invention improves the measurement of discrete locations around a pool for equipment installation by replacing the current A-B point-to-point triangulation method with a laser-based measurement tool that determines the distance from a reference point within the pool to the discrete location of interest. The device is positioned at the reference point of the pool and manually aimed at the location of interest, allowing the measurement of a variety of different types of features and locations. The device determines the geometrical position of that location with respect to the reference point and automatically transmits that location to a user storage device. The measurement device reduces human errors such as the misreading of measurement tapes and the incorrect transcription of measurements to digital formats. The scanning apparatus allows rapid collection of point locations, including automatic storage in digital format, thereby providing significant reductions in error rates.

### DETAILED DESCRIPTION

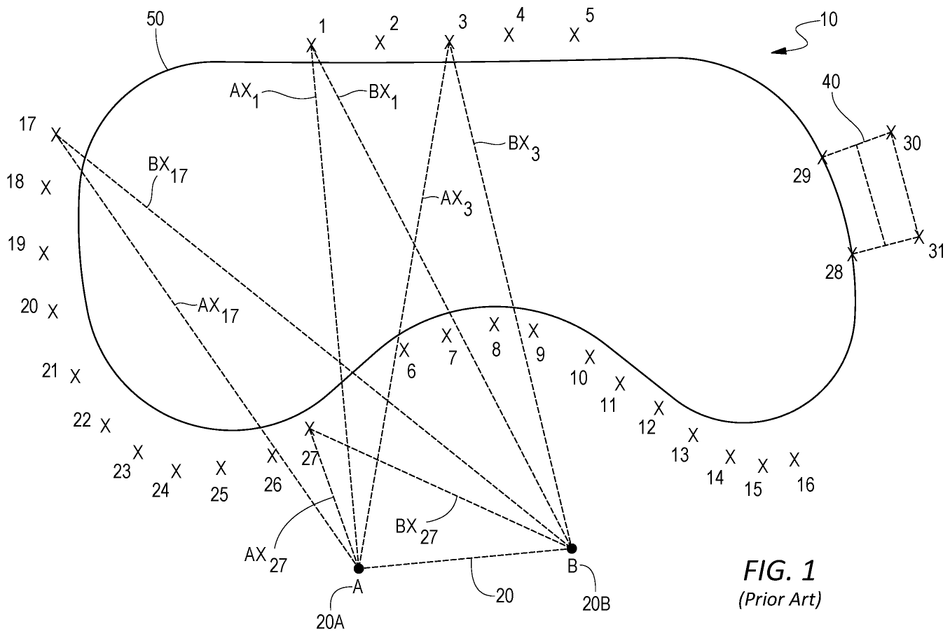

As shown in FIG. 1, the prior art method and apparatus used to measure the locations X of anchors around the perimeter 50 of pool 10 for equipment installations 40 involves “A-B point-to-point triangulation” wherein two reference points 20A and 20B are placed on the ground with a straight line between them (that does not intersect the pool 10) and a series of measurements are made to a plurality of points X along the perimeter 50. A series of measurements from each point X to each reference point 20A, 20B must be made. As shown by example in FIG. 1, the distance from point X1 to reference point 20A and to reference point 20B must be determined by measuring the length of the line AX1 and BX1 respectively. Other exemplary lines of measurement are shown in FIG. 1 including AX3, BX3, AX17, BX17, AX27 and BX27. As expected, the errors and inefficacies inserted in making many measurements can be great. These measurements then must be transferred to the equipment manufacturer, who then fabricates the equipment installations 40. At times, the errors generated in manually measuring the perimeter 50 are so great that the equipment installations 40 cannot be fitted to the pool 10 as desired.

In addition, prior art includes the shipment of original covers to the fabrication facility for measurement. In this scenario, the cover is first stretched out over the floor of the fabrication facility. The previously described A-B point-to-point triangulation method is used to measure the locations of the ends of the cover's straps. These straps connect to the anchors around the pool, so the end of the straps approximates the anchor locations. This measurement approach is less prone to human error since the procedure is performed in a controlled facility and can be easily performed multiple times if errors are found. However, this procedure is also prone to error since it relies on accurate stretching of the original cover and straps in its original as installed form. Achieving accurate placement of the straps is difficult. In addition, over time, covers and straps stretch, leading to a cover that is slightly a different shape than originally design. This issue leads to inaccurate cover measurements.

Both prior art measurements are prone to measurements inaccuracies, either due to human error or errors in the physical structure. Therefore, new methods are of interest.

The present invention is a measuring method and apparatus that provides precise accurate measurements of the geometrical position of discrete locations around a pool with respect to a reference point. The invention quickly collects and stores the measurements needed to create various structures, equipment, and geometries intended for installation on the pool. The invention reduces human errors such as the misreading of measurement tapes and the incorrect transcription of measurements to digital formats. The apparatus allows rapid collection of the point locations, including automatic storage in digital format, thereby providing significant reductions in error rates.

### Point Locator Device

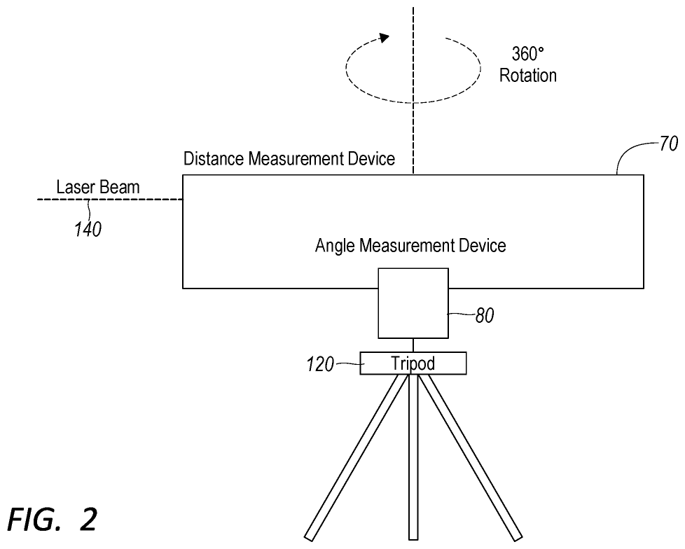

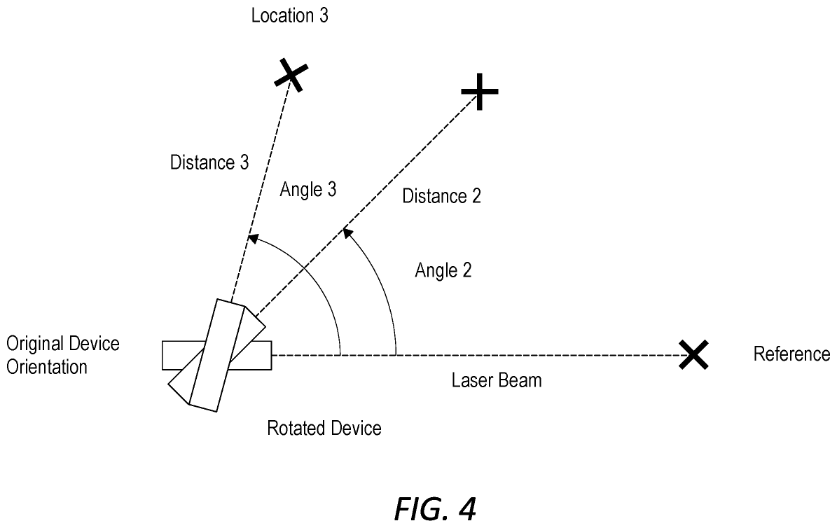

In the example shown in FIGS. 2-5, the present invention includes a laser measurement device 60 that measures discrete locations X around the perimeter 50 of a pool 10. The laser measurement device 60 includes a laser distance sensor 70 capable of emitting a laser beam 140. In this embodiment, the laser measurement device 60 includes an optical encoder 80, a microprocessor 90, a transmitter 110 and a battery 130. In other embodiments, the measurement device 60 may also include a cooling fan (not shown). The measurement device is adapted and/or configured to sit atop a standard tripod 120.

Generally, the laser distance sensor 70 is a time-of-flight optical device for measuring point-to-point distances. In one embodiment, it directs a laser beam 140 onto a marker at a discrete location and measures the time-of-flight required for the laser beam 140 to be reflected to a sensor within the laser distance sensor 70. The laser distance sensor 70, in one embodiment, may record the time-of-flight measurements referenced earlier in a database or it may transmit the time-of-flight measurements to a microprocessor 90 with an accompanying database.

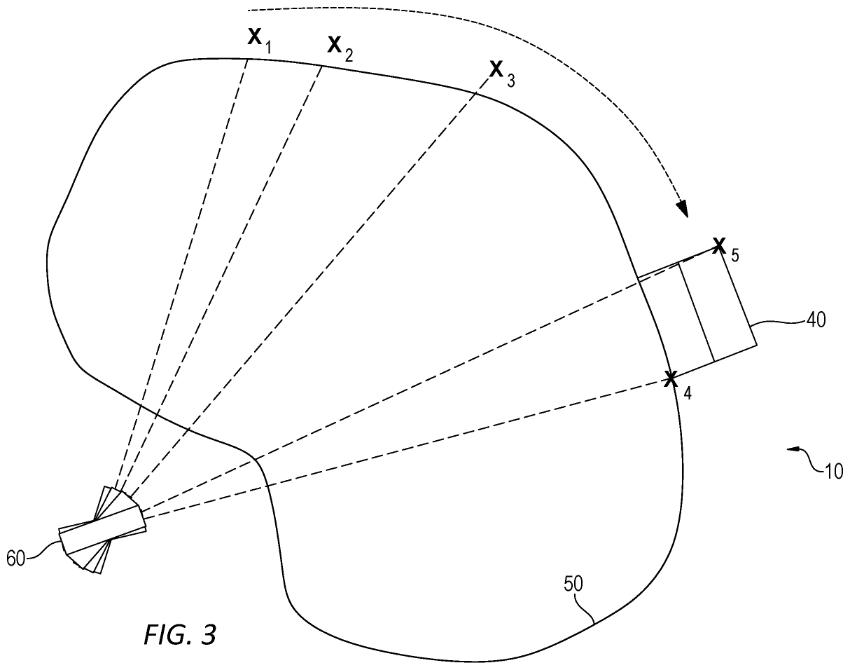

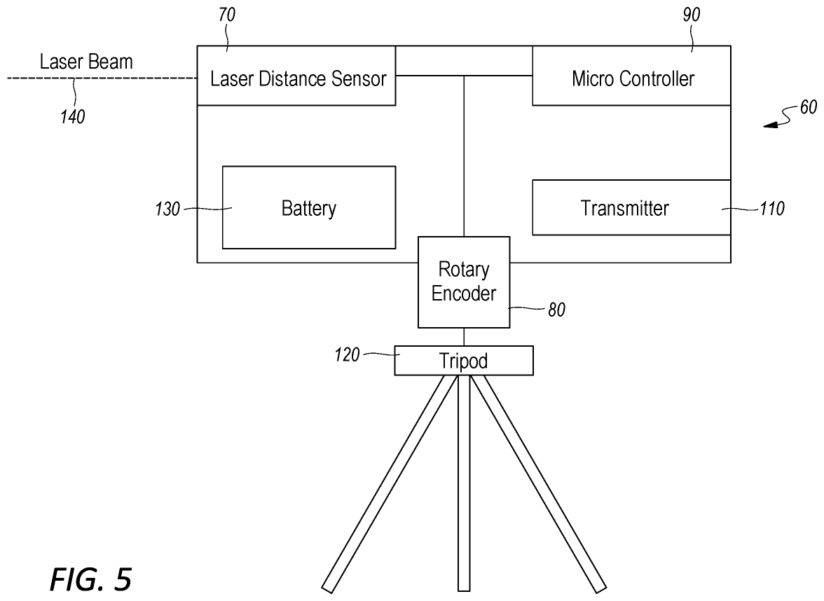

The optical encoder 80 is used to measure the angular position of the laser measurement device 60 about the x-axis over a 360-degree range with high-levels of precision. This allows the laser measurement device 60 to take time-of-flight measurements about the perimeter 50 of a pool as shown in FIGS. 3 and 5. Specifically, as shown in these figures, the laser measurement device 60 directs a laser beam 140 towards points X1, X2-Xₙ, and records and/or transmits the time-of-flight measurements associated with the distance between the laser measurement device 60 and each of the points X1, X2-Xₙ. The optical encoder 80 provides an angular measurement to the microprocessor 90 such that the rotation about the x-axis is known for corresponding points X1, X2-Xₙ. This angular position is used to calculate the measured point in two-dimensional coordinates.

The microprocessor 90 may be a single processor or multiple processors. Additionally, the processor 90 may be in communication with a storage device or a storage medium. The processor executes an appropriate operating system such as Linux, Unix, Microsoft® Windows® and the like. The processor 90, and the storage device/medium, may advantageously contain control logic, program logic, or other substrate configuration representing data and instructions, which cause the processor 90 to operate in a specific and predefined manner.

The laser measurement device 60 also includes a transmitter 110. The transmitter 110 is adapted and/or configured to transmit the time-of-flight measurements made by the laser distance sensor 70 and/or the microprocessor 90 to a mobile hand-held device (not shown). In one embodiment, the transmitter 110 and the mobile hand-held device may be on the same Wi-Fi network while in another embodiment, the transmitter 110 may transmit the time-of-flight measurements via Bluetooth™ or other low energy wireless transmission technology to a mobile hand-held device capable of receiving transmissions via Bluetooth™ or other wireless transmission protocols. In one embodiment, the mobile hand-held device may be a “smart phone” such as an Apple iPhone™ or Samsung Galaxy™ device or a wireless tablet device such as an iPad™.

The mobile hand held device may have an downloadable application (or “app”) which is designed to receive the time-of-flight measurements made by the laser measurement device 60 and re-transmit those time-of-flight measurements via a cellular network to a host server which may be housed at, or in communication with, the pool equipment manufacturer (as is discussed in more detail below). Additionally, in some embodiments, as shown in FIG. 5, the laser measurement device 60 may include a battery charging function and the associated connectors and switches.

In particular, the computer programs described for the operation of the apparatus, when executed, enable a processor to perform and/or cause the performance of features of the present invention. The control logic may advantageously be implemented as one or more modules. The modules may advantageously be configured to reside on the storage device/medium and execute on the one or more processors. The modules include, but are not limited to, software or hardware components that perform certain tasks. Thus, a module may include, by way of example, components, such as, software components, processes, functions, subroutines, procedures, attributes, class components, task components, object-oriented software components, segments of program code, drivers, firmware, micro-code, circuitry, data, and the like. The control logic conventionally includes the manipulation of data bits by the processor and the maintenance of these bits within data structures in one or more of the memory storage devices. Such data structures impose a physical organization upon the collection of data bits stored within computer memory and represent specific electrical or magnetic elements. These symbolic representations are the means used by those skilled in the art to effectively convey teachings and discoveries to others skilled in the art.

The control logic is generally considered to be a sequence of computer-executed steps. These steps generally require manipulations of physical quantities. Usually, although not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, text, terms, numbers, records, files, or the like. It should be kept in mind, however, that these and some other terms should be associated with appropriate physical quantities for computer operations, and that these terms are merely conventional labels applied to physical quantities that exist within and during operation of the processor.

### Methods of Operation

As mentioned, the apparatus is controlled by an embedded microcontroller. The microcontroller accepts commands from the user and operates the components within the apparatus according to those commands. The apparatus is intended to be operated manually with the user in close proximity to the device, turning the device to point at locations of interest. However, while not required in the preferred embodiment, the device is desired to operate wirelessly. Therefore, it includes both a battery and a wireless transmitter. One embodiment uses a Wi-Fi connection allowing it to be controlled from a variety of laptops and handheld devices. Another embodiment would utilize Bluetooth communication.

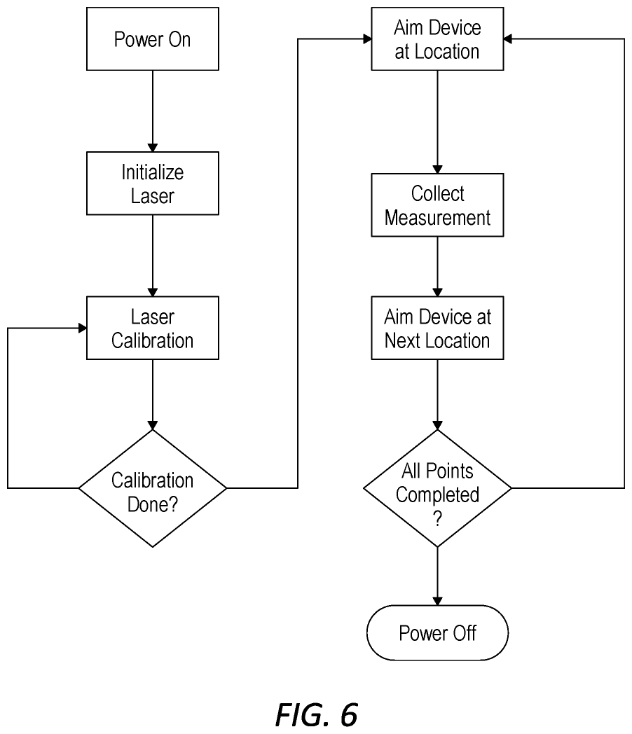

As shown in FIG. 6, at the beginning of the measurement process, the microcontroller turns on the laser distance sensor and waits for the calibration to complete. Then, the operator rotates the device about its axis to point at the first measurement location. When the unit has been aimed at the first measurement location, the user presses a button on the remote control. The remote control then instructs the measurement device to take a distance measurement and to store the angle of the device as measured by the rotary encoder. These data points are then transmitted to the remote control for storage. This process is repeated until all of the desired locations have been measured.

Surface reflectivity, incident angle, and ambient light conditions can affect laser sensor performance. In addition, some locations of interest do not have a surface available at which the laser can reflect, making them impossible to measure. Therefore, the present invention includes the use of a highly reflective marker placed at measurement locations to provide a suitable surface for laser location, as the reflective surface allows the operator to easily identify the location of the laser beam. Then, the reflective surface is removed so that the laser spot is incident upon the dispersive surface of the anchor location being interrogated, allowing an accurate measurement of the distance and angle to the location.

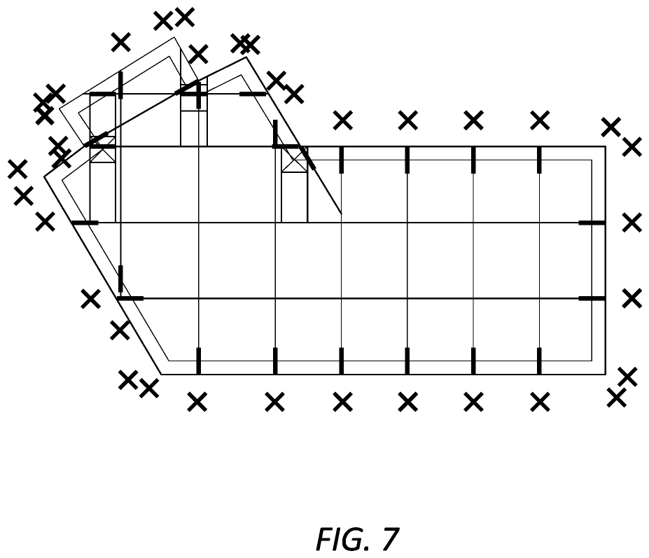

The method for apparatus use consists of the operator first placing the unit on the tripod at a suitable location outside or if the pool is drained, inside the pool that has an unobstructed line of sight to all points to be measured. Operator helper places a specifically designed “location marker” (not shown) to the point of interest XX as shown in FIG. 7. This location marker provides a highly reflective surface for optimal laser location and a dispersive surface for accurate distance measurement. After operator helper places the location marker at the first point of interest, the operator points the measurement device at the marker, allowing the determination of distance to the marker and angle to the marker, further allowing calculation of location position in three-dimensional space. Operator helper then moves the location marker sequentially to the next point of interest, allowing the determination of distance to the marker and angle to the marker, further allowing calculation of location position in three-dimensional space. continuing this process until all points of interest have been recorded.

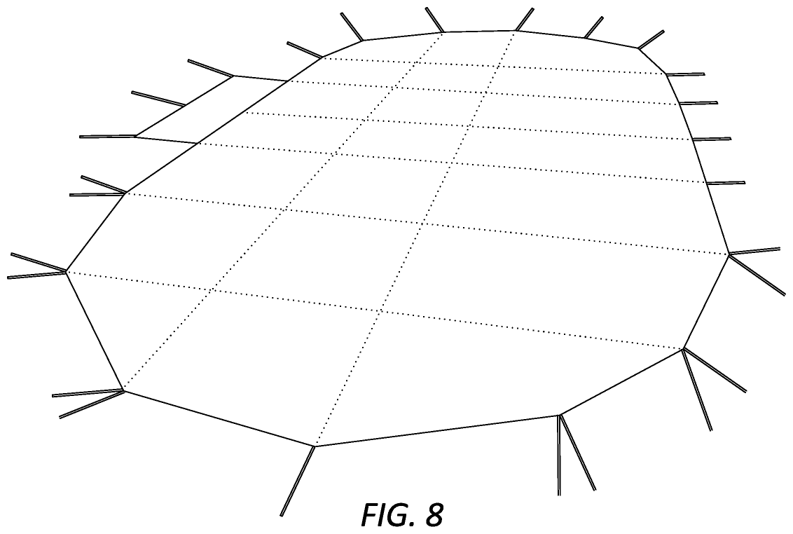

During operation, data from the apparatus is sent to the remote-control device. The data consists of both the angular position of the device and the distance measured to the reflective surface. The remote control converts the data to a two-dimensional format using a standard coordinate transformation from Polar to Cartesian coordinates. The data is then plotted on the remote-control device to enable a quick evaluation of the location positions. The data is also sent in electronic format to the designers of the pool equipment in the form of a point cloud. Designers convert this point data cloud to data points required for functions such as cover design. FIG. 8 shows an example of the results of a measurement sequence.

Although particular embodiments of the present disclosure have been described, it is not intended that such references be construed as limitations upon the scope of this disclosure except as set forth in the claims.

We claim:

1. A method of measuring discrete locations around a perimeter of a pool, the method comprising:
a. positioning a laser measurement device at a reference point;
b. aiming the laser measurement device at a discrete location of interest;
c. determining the geometrical position and location of the discrete location of interest relative to the reference point; and
d. storing the geometrical position and location of the discrete location of interest in a database.

2. The method of claim 1 wherein the laser measurement device comprises a laser distance sensor capable of emitting a laser beam.

3. The method of claim 2 wherein the laser measurement device comprises an optical encoder, a microprocessor, a transmitter and a battery.

4. The method of claim 1 wherein the laser distance sensor is a time-of-flight optical device.

5. The method of claim 1 wherein the geometrical position and location of the discrete location of interest is transmitted to a user storage device and stored in a database.

6. The method of claim 5 wherein the user storage device is a mobile handheld device.

7. The method of claim 6 wherein the geometrical position and location of the discrete location of interest is transmitted to the mobile handheld device via low energy wireless transmission network or a Wi-Fi network.

8. The method of claim 7 wherein the mobile handheld device is a cellular phone.

9. The method of claim 3 wherein a plurality of discrete locations of interest are identified and the geometrical position and location of each discrete locations of interest relative to the reference point is determined.

10. The method of claim 1 wherein the laser measurement device is placed on a tripod.

11. The method of claim 10 wherein the laser measurement device rotates about an x-axis relative the tripod.

12. A method of measuring discrete locations around a perimeter of a pool, the method comprising:
a. positioning a laser measurement device at a reference point, said laser measurement device is placed on a tripod;
b. aiming the laser measurement device at a discrete location of interest;
c. determining the geometrical position and location of the discrete location of interest relative to the reference point; and
d. transmitting the geometrical position and location of the discrete location of interest is transmitted to a mobile handheld device.

13. The method of claim 12 wherein the laser measurement device rotates about an x-axis relative the tripod.

14. The method of claim 12 wherein the geometrical position and location of the discrete location of interest is transmitted to the mobile handheld device via low energy wireless transmission network or a Wi-Fi network.

15. The method of claim 14 wherein the geometrical position and location of the discrete location of interest is transmitted to the mobile handheld device via low energy wireless transmission network or a Wi-Fi network.

16. The method of claim 12 wherein the mobile handheld device is a cellular phone.

17. The method of claim 13 wherein the mobile handheld device is a cellular phone.

18. The method of claim 15 wherein the mobile handheld device is a cellular phone.
